(19) United States
(12) Patent Application Publication
(10) Pub. No.: US 2002/0137540 A1
(43) Pub. Date: Sep. 26, 2002

(54) Management system kit used for the host of serial PDA or handheld PC

(76) Inventor: Roger Yu, Taipei (TW)

Correspondence Address: BACON & THOMAS, PLLC, 4th Floor, 625 Slaters Lane, Alexandria, VA, 22314-1176, US

(21) Appl. No.: 09/813,790

(22) Filed: Mar. 22, 2001

(51) Int. Cl. H04M 1/00

(52) U.S. Cl. 455/556; 455/550; 455/557

(57) ABSTRACT

A kind of “Management System Kit Used for the Host of Serial PDA or Handheld PC (HHPC)” that can be used by the host of PDA or handheld PC to manage or access data and brings unlimitedly expandable capability to PDA with small memory capacity. It is small and easily portable, and mainly composed of a memory management system and a data conversion control mechanism installed with a serial input/output device, CPU, firmware program, storage device and power supply. The data and programs in both of the PDA host and the data conversion control mechanism are managed and mutually delivered by embedding the memory management system in the PDA host and connecting the PDA host to the data conversion control mechanism through a serial port.

### BACKGROUND OF THE INVENTION

This invention is related to a kind of “Management System Kit Used for the Host of Serial PDA or Handheld PC (HHPC)” with a memory management system embedded in the host that is connected through a serial port to a data conversion controller composed of a serial input/output device, CPU, firmware program, storage device and power supply to perform the management and mutual delivery of data and programs.

### BRIEF DESCRIPTION OF THE INVENTION

The PDA or handheld PC (HHPC) nowadays features its lightness, thinness, shortness and smallness and has high portability. However, it has its disadvantages in limited space structure, small storage space and insufficient programs and users must usually connect it to an ordinary computer to store files. Taking the must popular host used for PDA as an example, it has only a 8 MB DRAM and only about 2 MB space is left when access a Chinese program system. This decreases the convenience in practical use.

Purpose of Invention:

The purpose of this invention is to provide a management system kit with small volume, high portability, easy connection, storage capability and program computing function used for serial PDA or handheld PC (HHPC).

Another purpose of this invention is to provide a storage device with an unlimitedly expandable memory capacity that will be used as a substitute for the small memory capacity of PDA or handheld PC to improve the convenience for users

### Detailed Description

To show the technology, features and performance of this invention more clearly, a preferred embodiment with illustrations and drawing numbers is described as follows

### BRIEF DESCRIPTION OF DRAWINGS

FIG. 1 is the block chart showing this invention and the internal actions of the host.

FIG. 2 is the flow chart showing the system operation after this invention and the host are connected.

### DETAILED DESCRIPTION OF PREFERRED EMBODIMENTS

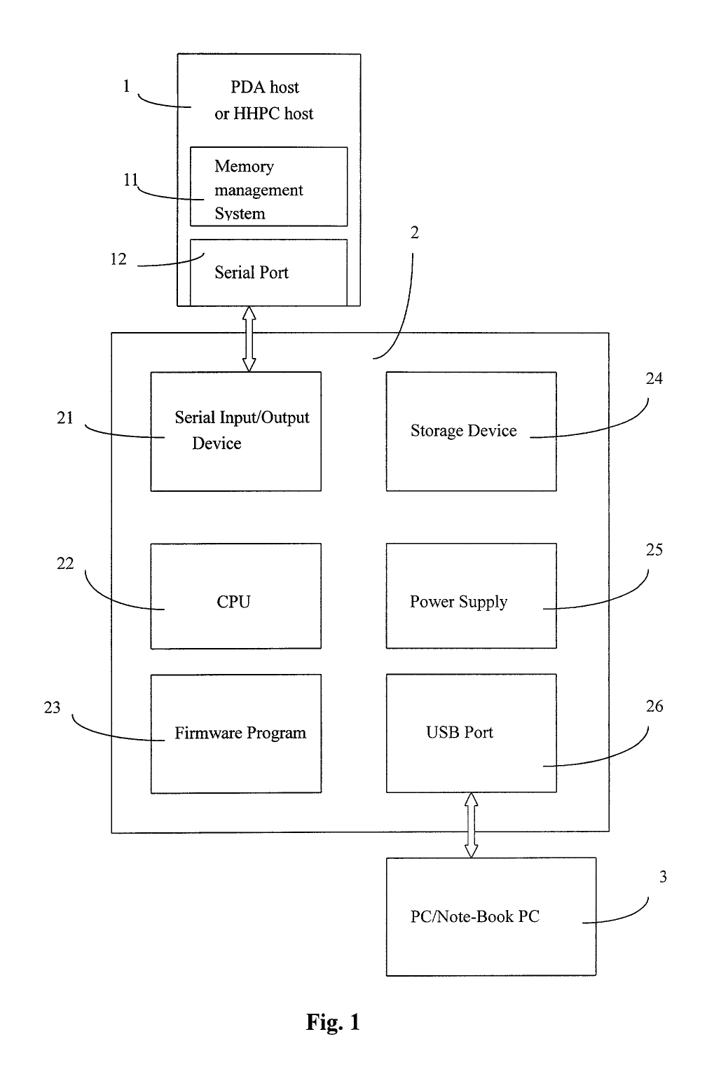

FIG. 1 is the block chart showing this invention and the inter actions of the host for PDA or handheld PC (HHPC) The main structure consists in the embedment of a memory management system (11) in the host of PDA or handheld PC (1) and the data conversion control mechanism (2) contains the units of serial input/output device (21), CPU (22), firmware (23), storage device (24), power supply (25) and USB port (26). The host of PDA or handheld PC embedded with a memory management system (11) is through its serial port (12) connected to the serial input/output device (21) of the data conversion control mechanism (2) to mutually deliver the data and programs of both the host (1) and data conversion control mechanism (2) under the management of the memory management system (11). The main function of CPU (22) is to control the data conversion control mechanism (2). To ensure that the power of the data conversion control mechanism can be used for a long period, CPU shall be equipped with a low-power and high-speed processor. The firmware device (23) is used as the main control program of the data conversion control mechanism (2) with the function mainly to receive and perform the host commands from serial port (12). The firmware program has Power-On-Self-Test (POST), transmission and command processing functions and can be placed in the Read-Only memory or programmed directly in the Read-Only memory in CPU (22). When the power supply is turned on, the firmware program (23) will enable POST to test all circuits and program functions and send the results to the host (1). The main purpose of the program transmission function is to keep the host (1) online, while that of the command processing function is to receive and perform the commands from the memory management system (11) in the host (1).

The function of the storage device (24) is to store data and programs for the use of the host (1). In addition to DRAM, Flash, or hard drives, it contains a power supply (25) to power the internal circuits of the data conversion control mechanism (2). The power supply (25) can be a re-charging or ordinary alkaline battery and can, depending on storage devices, provide different power. The host (1) may operate energy saving command to save energy.

To facilitate the transmission of files from ordinary PCs or Note-Book PCs to the host (1), a USB port (26) is installed in the data conversion control mechanism (2) to connect the ordinary PC or Note-Book PC from which the files are to be input directly into the storage device (24) of the data conversion control mechanism (2). If a charging battery is used as the power supply of the data conversion control mechanism (2), it can be charged with the USB port (26).

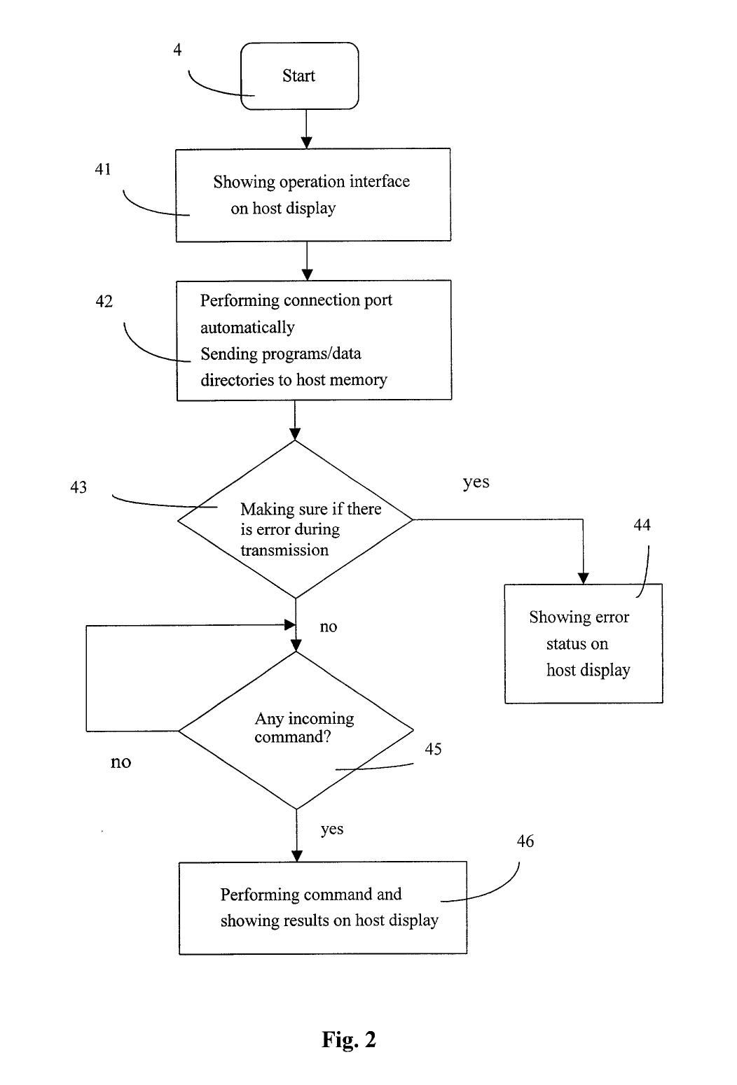

The aforementioned description shows the layout and functions of the internal hardware units constituting the data conversion control mechanism (2). FIG. 2 is the flow chart showing the system operation after this invention in connected to the host. Please refer to FIG. 2 together with FIG. 1. When the power supply of the machine (1) is turned on, the host (1) operates its internal memory management system (11) immediately and shows the operation interface (41) on the display of the host (1). The memory management system (11) test the connection between the serial port (12) of the host (1) and the serial input/output device (21) of the data conversion control system (11) automatically and sends the programs or the directories of the programs or data in the storage device of the data conversion control mechanism (2) to the memory (42) of the host (1). The memory management system (11) makes sure whether there is no error during the transmission (43). If there is any error, the error status will be shown on the display (44) of the host (1). If there is no error during the transmission, the memory management system (11) will further make sure whether any command is input in (45). If there is any input command, it will be shown on the display (46) of the host (1). Whether the power is turned on or not, the data conversion controller (2) can be connected to the serial port (12) of the host (1) at any time based on the demand of the user.

It is confirmed based on the aforementioned description that there is no other technology similar to that of the invented management system kit used for the host of serial PDA or handheld PC (HHPC). For people who are familiar with this technology, all modifications that are made to this invention and do not exceed the spirit of this invention shall be regarded as part of the patent application of this invention.

What I claim is:

1. A kind of “Management System Kit Used for the Host of Serial PDA or Handheld PC (HHPC)” bringing unlimitedly expandable capability to PDA with small memory capacity, mainly contains:
A memory management system to control the memory or DRAM in the host of PDA or handheld PC (HHPC) and the storage device of the data conversion control mechanism connected to the serial port externally.
A data conversion control mechanism mainly composed of a serial input/output, CPU, firmware program, storage device and power supply.
The programs and data files in the host of PDA and the data conversion control units can by managed and mutually delivered by embedding the memory management system in the host of PDA or handheld PC (HHPC) and connecting the serial port of the PDA host and the data conversion control mechanism.

2. The management system kit used for serial PDA or handheld PC (HHPC) as recited in claim 1, wherein the CPU in the data conversion control mechanism is preferably equipped with a low-power and high-speed processor.

3. The management system kit used for serial PDA or handheld PC (HHPC) as recited in claim 1, wherein the power supply of the data conversion control mechanism is a re-charging or alkaline battery.

4. The management system kit used for serial PDA or handheld PC (HHPC) as recited in claim 1, wherein the storage device is a hard drive, flash or DRAM.

5. The management system kit used for serial PDA or handheld PC (HHPC) as recited in claim 1, wherein the data conversion control mechanism is installed with a USB port to connect to ordinary PC or Note-Book PC.

6. The management system kit used for serial PDA or handheld PC (HHPC) as recited in claim 1, wherein the data conversion control mechanism is installed with a USB port used for the charge of the power supply.
